(19) United States
(12) Patent Application Publication
(10) Pub. No.: US 2016/0225088 A1
(43) Pub. Date: Aug. 4, 2016

(54) Customized and Beneficial Asset Withdrawal

(71) Applicant: FMR LLC, Boston, MA (US)

(72) Inventors: Brian J. Dennis, Marblehead, MA (US); Faiz Melhem, Brookline, MA (US); Kristina M. Regan, Walpole, MA (US)

(21) Appl. No.: 14/608,993

(22) Filed: Jan. 29, 2015

(51) Int. Cl. G06Q 40/06

(52) U.S. Cl. CPC G06Q 40/06

(57) ABSTRACT

Methods and apparatuses, including computer program products, are described for determining a customized and beneficial asset withdrawal from an investment portfolio account. A server computing device receives (i) customer portfolio data associated with a customer's investment portfolio account, (ii) research data associated with securities and share amounts, and (iii) customer preference data. An optimization engine executing in the server analyzes the customer portfolio data, research data, and customer preference data to generate an asset withdrawal optimization plan. The engine determines a proposed withdrawal of securities and share amounts out of the account, where the proposed withdrawal maximizes a benefit value to the customer and matches a predetermined asset withdrawal amount. The engine selects a set of securities and share amounts in the account that conforms to the proposed withdrawal and generates the optimization plan. The engine transmits the optimization plan to a remote device.

### TECHNICAL FIELD

This application relates generally to methods and apparatuses, including computer program products, for determining a customized and beneficial asset withdrawal from an investment portfolio account.

### BACKGROUND

Investment customers that own personal investment portfolio accounts often express the intention of withdrawing assets from the portfolio. Such customers seek detailed recommendations on which securities should be withdrawn in order to both meet a desired withdrawal amount while also maximizing the benefit to the customer (e.g., withdrawing securities yet still retaining a distribution or asset mix desired by the customer).

In addition, customers frequently have a set of optimization criteria that they want to apply to their portfolio account. For example, certain industry ratings and/or asset weights may be more important to certain customers relative to other customers that may place importance on different criteria.

Such recommendations require detailed, complex analysis of a customer's portfolio account (i.e., the specific securities and share amounts held in the account) in conjunction with the customer's optimization criteria, weights, and preferences to arrive at a proposed asset withdrawal that satisfies all of the above requirements.

### SUMMARY

Therefore, what is needed is a system and method for customized and beneficial asset withdrawal from an investment portfolio account. The techniques described herein provide the advantage of analyzing a portfolio account according to a host of optimization criteria designated by the customer owning the account and determining an asset withdrawal that both meets a desired withdrawal amount and achieves a maximum benefit value for the customer. The techniques described herein also provide the advantage of generating such asset withdrawal recommendations quickly and accurately using a specific optimization engine designed to process a plurality of complex data sources including an array of shares held in the portfolio account, determine asset withdrawal scenarios based upon a benefit value, and designate a proposed asset withdrawal that would benefit the customer while conforming to the customer's preferences and desired withdrawal amount.

The invention, in one aspect, features a computerized method for determining a customized and beneficial asset withdrawal from an investment portfolio account. A server computing device receives, from a plurality of data sources, (i) customer portfolio data associated with a customer's investment portfolio account, the account containing a plurality of securities, (ii) research data associated with the plurality of securities, and (iii) customer preference data. An optimization engine executing in the server computing device analyzes the customer portfolio data, research data, and customer preference data to generate an asset withdrawal optimization plan for the investment portfolio account. The optimization engine determines a proposed withdrawal of securities out of the investment portfolio account, where the proposed withdrawal maximizes a benefit value to the customer based upon at least a number of securities in the investment portfolio account, optimization criteria selected by the customer, and a weight assigned to each of the optimization criteria by the customer, and matches a predetermined asset withdrawal amount. The optimization engine selects a set of securities in the portfolio account that conforms to the proposed withdrawal and generates the asset withdrawal optimization plan based upon the selected set of securities, where the asset withdrawal optimization plan illustrates one or more effects on the portfolio account when the selected set of securities is withdrawn from the portfolio account. The optimization engine transmits the asset withdrawal optimization plan to a remote computing device.

The invention, in another aspect, features a computerized system for determining a customized and beneficial asset withdrawal from an investment portfolio account. The system comprises a server computing device configured to receive, from a plurality of data sources, (i) customer portfolio data associated with a customer's investment portfolio account, the account containing a plurality of securities and share amounts, (ii) research data associated with the plurality of securities and share amounts, and (iii) customer preference data. The system comprises an optimization engine executing on the server computing device, the optimization engine configured to analyze the customer portfolio data, research data, and customer preference data to generate an asset withdrawal optimization plan for the investment portfolio account. The optimization engine determines a proposed withdrawal of securities and share amounts out of the investment portfolio account, where the proposed withdrawal maximizes a benefit value to the customer based upon at least a number of securities in the investment portfolio account, optimization criteria selected by the customer, and a weight assigned to each of the optimization criteria by the customer, and matches a predetermined asset withdrawal amount. The optimization engine selects a set of securities and share amounts in the portfolio account that conforms to the proposed withdrawal and generates the asset withdrawal optimization plan based upon the selected set of securities and share amounts, where the asset withdrawal optimization plan illustrates one or more effects on the portfolio account when the selected set of securities and share amounts is withdrawn from the portfolio account. The optimization engine transmits the asset withdrawal optimization plan to a first remote computing device.

The invention, in another aspect, features a computer program product, tangibly embodied in a non-transitory computer readable storage medium, for determining a customized and beneficial asset withdrawal from an investment portfolio account. The computer program product includes instructions operable to cause a server computing device to receive, from a plurality of data sources, (i) customer portfolio data associated with a customer's investment portfolio account, the account containing a plurality of securities and share amounts, (ii) research data associated with the plurality of securities and share amounts, and (iii) customer preference data. The computer program product includes instructions operable to cause an optimization engine executing on the server computing device to analyze the customer portfolio data, research data, and customer preference data to generate an asset withdrawal optimization plan for the investment portfolio account. The optimization engine determines a proposed withdrawal of securities and share amounts out of the investment portfolio account, where the proposed withdrawal maximizes a benefit value to the customer based upon at least a number of securities in the investment portfolio account, optimization criteria selected by the customer, and a weight assigned to each of the optimization criteria by the customer, and matches a predetermined asset withdrawal amount. The optimization engine selects a set of securities and share amounts in the portfolio account that conforms to the proposed withdrawal and generates the asset withdrawal optimization plan based upon the selected set of securities and share amounts, where the asset withdrawal optimization plan illustrates one or more effects on the portfolio account when the selected set of securities and share amounts is withdrawn from the portfolio account. The optimization engine transmits the asset withdrawal optimization plan to a first remote computing device.

Any of the above aspects can include one or more of the following features. In some embodiments, a trading engine coupled to the server computing device automatically executes a plurality of security transactions based upon the asset withdrawal optimization plan to withdraw the selected set of securities and share amounts from of the investment portfolio account. In some embodiments, maximization of the benefit value is determined by

$$max {\sum }_{i = 1}^{s} {\sum }_{j = 1}^{c} {r}_{j} * {benefit}_{i , j}$$

$${benefit}_{i , j} = {f}_{j} ( Δ {weight}_{i} )$$

$${\sum }_{i = 1}^{s} Δ {weight}_{i} = giftWeight$$

wherein

s=the number of securities in the portfolio account,

c=the number of optimization criteria,

r=the weight assigned to each criteria, and

f=the proprietary benefit calculation for each of the criteria.

In some embodiments, the set of customer portfolio data includes customer-specific benchmark data corresponding to a level of investment risk desired by the customer. In some embodiments, the customer-specific benchmark data includes a set of broad asset-class level target weights and a set of narrow asset-class level target weights.

In some embodiments, the set of customer portfolio data includes security data associated with the plurality of securities in the account. In some embodiments, the security data includes current price, broad asset class classification, narrow asset class classification, active/passive classification, distribution analysis data, acquisition price, and acquisition date. In some embodiments, the research data associated with the plurality of securities and share amounts includes fundamental analyst security ratings, quantitative model security ratings, and portfolio manager alpha scores.

In some embodiments, the customer preference data includes the predetermined asset withdrawal amount. In some embodiments, the customer preference data includes identification of at least some of the optimization criteria and the weight assigned to each of the optimization criteria. In some embodiments, the weight signifies a relative importance of each of the optimization criteria to the customer. In some embodiments, the customer preference data is provided by the customer via a remote computing device coupled to the server computing device.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for determining a customized and beneficial asset withdrawal from an investment portfolio account.

FIG. 2 is a flow diagram of a method for determining a customized and beneficial asset withdrawal from an investment portfolio account.

FIG. 3 is an exemplary user interface for providing user-selected optimization criteria for use in determining a customized and beneficial asset withdrawal from an investment portfolio account.

FIG. 4 is a detailed block diagram of the optimization engine of FIG. 1.

FIGS. 5A through 5C are elements of an exemplary asset withdrawal optimization plan generated by the optimization engine of FIGS. 1 and 4.

FIG. 6 is an exemplary asset withdrawal and impact report generated by the optimization engine of FIGS. 1 and 4.

### DETAILED DESCRIPTION

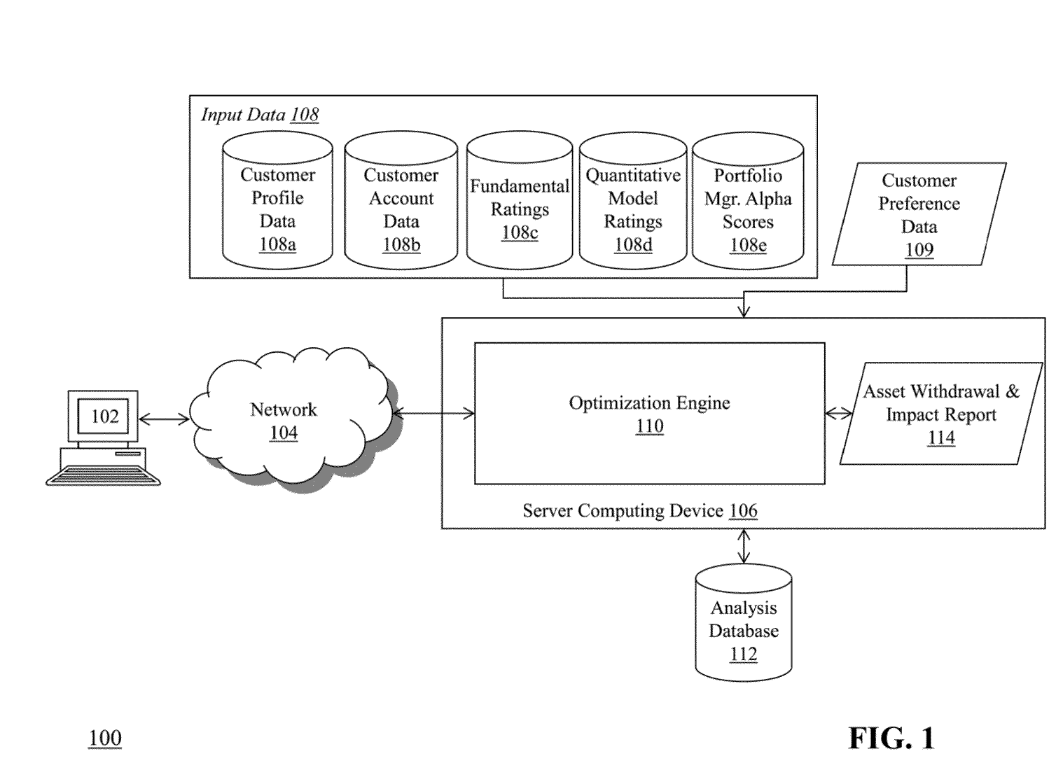

FIG. 1 is a block diagram of a system 100 for determining a customized and beneficial asset withdrawal from an investment portfolio account. The system 100 includes a client device 102, a communications network 104, a server computing device 106 coupled to an analysis database 112, input data 108 available from a plurality of databases/data feeds 108a-108e, customer preference data 109, an optimization engine 110 executing within the server computing device 106, and an asset withdrawal and impact report 114 as output.

The client device 102 connects to the server computing device 106 via the communications network 104 in order to initiate the asset withdrawal analysis and execution process described herein, to provide user-selected optimization criteria inputs and personalized user preferences to the optimization engine 110, and to receive the asset withdrawal and impact report, and other associated information, from the server computing device 106. Exemplary client devices include desktop computers, laptop computers, tablets, mobile devices, smartphones, and internet appliances. It should be appreciated that other types of computing devices that are capable of connecting to the server computing device 106 can be used without departing from the scope of invention. Although FIG. 1 depicts a single client device 102, it should be appreciated that the system 100 can include any number of client devices.

The communication network 104 enables the client device 102 to communicate with the server computing device 106 in order to perform the asset withdrawal analysis and execution process described herein, to provide user-selected optimization criteria inputs and personalized user preferences to the optimization engine 110, and to receive the asset withdrawal and impact report, and other associated information, from the server computing device 106. The network 104 may be a local network, such as a LAN, or a wide area network, such as the Internet and/or a cellular network. In some embodiments, the network 104 is comprised of several discrete networks and/or sub-networks (e.g., cellular to Internet) that enable the client device 102 to communicate with the server computing device 106.

The server computing device 106 receives input data 108 from a plurality of data sources (e.g., databases, data feeds). As shown in FIG. 1, the data sources include customer profile data 108a, customer account data 108b, fundamental ratings 108c, quantitative model ratings 108d, and portfolio manager alpha scores 108e. It should be appreciated that the input data 108 can be provided by different data providers or sources. For example, a financial institution that manages a customer's investment portfolio account can provide the customer profile data 108a and the customer account data 108b, while the fundamental ratings 108c, quantitative model ratings 108d, and portfolio manager alpha scores 108e can be provided by third-party/industry sources (e.g., a subscription data feed or database). In addition, the input data 108 can include other sources and/or types of information not expressly shown in FIG. 1, to be used by the server computing device 106 and optimization engine 110 to perform the asset withdrawal analysis and execution process described herein.

Also, the server computing device 106 receives customer preference data 109 for use in performing the asset withdrawal analysis and execution process. The customer preference data includes information relating to the amount (e.g., in dollar value and/or specific types of assets) that the customer wants to withdrawal from the investment portfolio account. The customer preference data 109 also includes information indicative of the customer's preferences and/or goals in initiating the asset withdrawal. For example, the customer can provide an indication of the relative importance/priority to him or her of certain metrics (also called optimization criteria) employed by the optimization engine 110 in generating an asset withdrawal optimization plan, such as: broad asset-class level allocation, narrow asset-class level allocation, portfolio attributes (e.g., active/passive), fundamental security ratings, quantitative model security ratings, and portfolio manager security alpha scores. For example, a customer may prefer that the fundamental security ratings associated with securities and share amounts in the investment portfolio account are more important than portfolio manager security alpha scores when making an asset withdrawal decision. Thus, the customer may provide an indication (e.g., a weight) of the relative importance of these factors to the optimization engine 110.

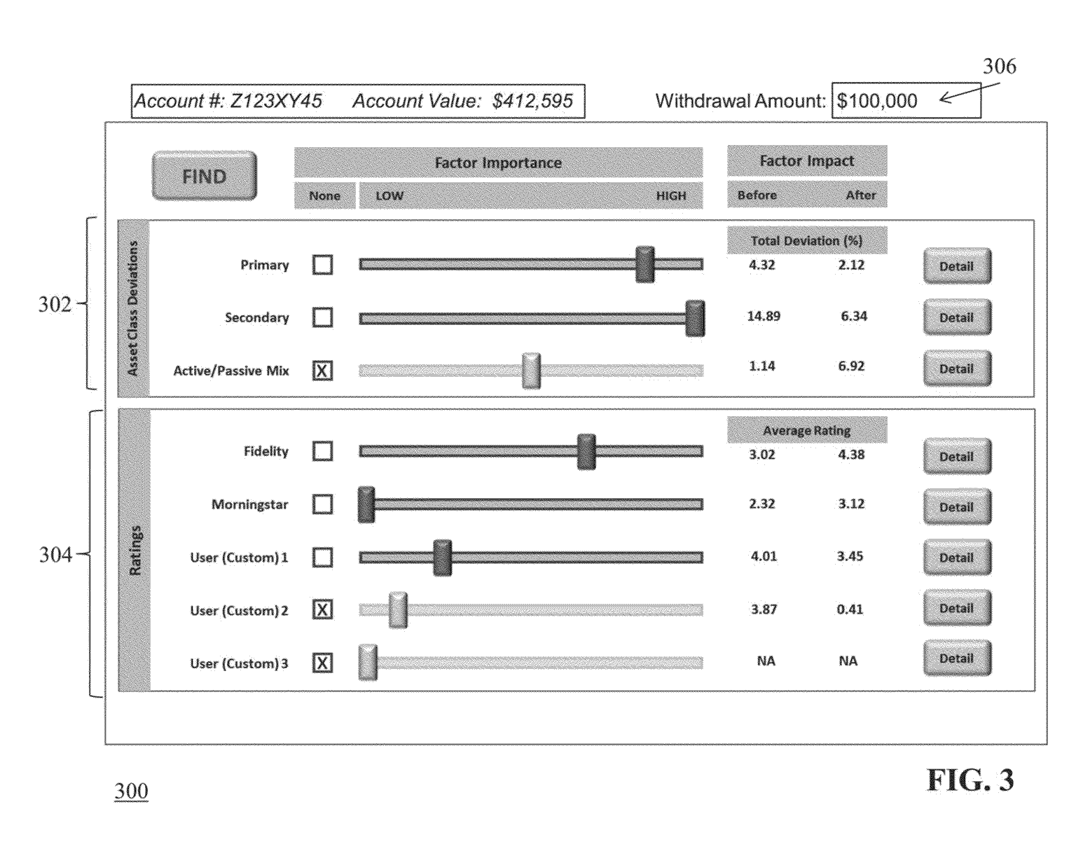

In some embodiments, the customer preference data 109 is provided in advance by a customer and stored in database 112. In some embodiments, the customer accesses the server computing device 106 via the client device 102 and provides some or all of the customer preference data 109 in real time to the optimization engine 110 via a user interface located on the client device 102. An exemplary user interface is set forth in FIG. 3, which will be described in greater detail below.

The system 100 also includes a database 112. The database 112 is coupled to the server computing device 106 and stores data used by the server computing device 106 to perform the asset withdrawal analysis and execution process. The database 112 can be integrated with the server computing device 106 or be located on a separate computing device. An example database that can be used with the system 100 is MySQL™ available from Oracle Corp. of Redwood City, Calif.

The server computing device 106 includes an optimization engine 110. The engine 110 is a specialized hardware and/or software module executing within the server computing device 106 to perform the asset withdrawal analysis and execution process described herein, and to transmit the generated asset withdrawal and impact report to remote computing devices (e.g., device 102). In some embodiments, the functionality of the optimization engine 110 can be distributed among a plurality of computing devices. It should be appreciated that any number of computing devices, arranged in a variety of architectures, resources, and configurations (e.g., cluster computing, virtual computing, cloud computing) can be used without departing from the scope of the invention. The exemplary functionality of the optimization engine 110 will be described in greater detail below.

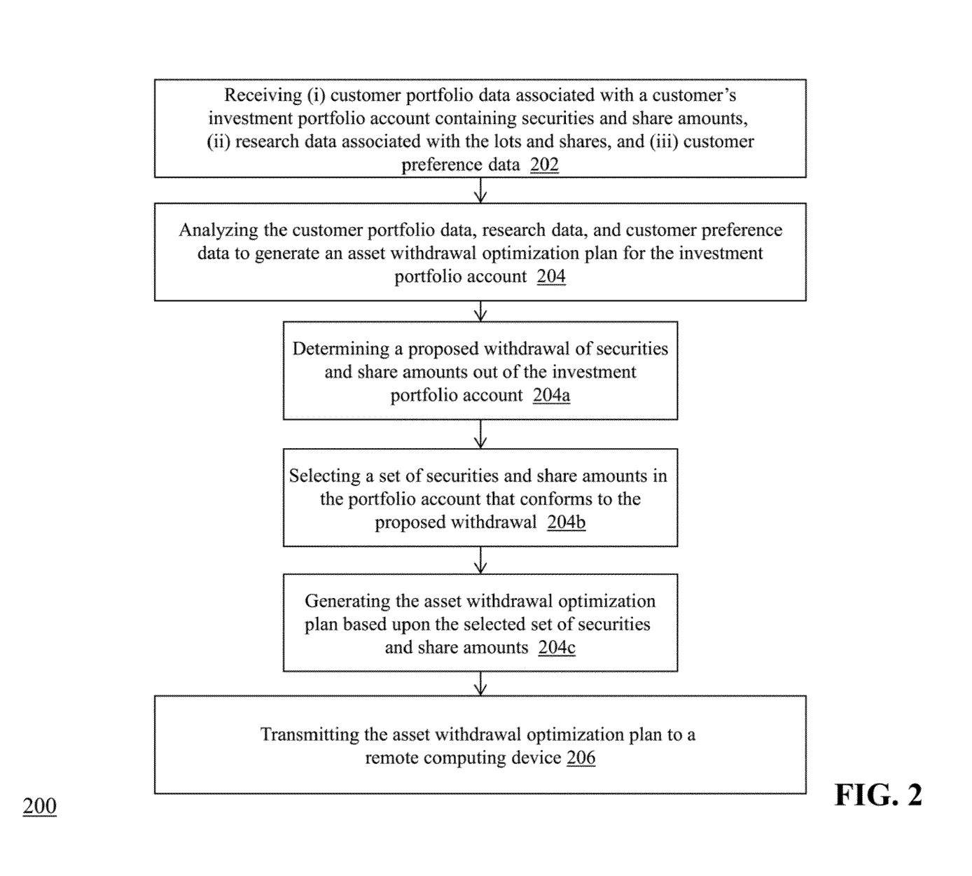

FIG. 2 is a flow diagram of a method 200 for determining a customized and beneficial asset withdrawal from an investment portfolio account, using the system 100 of FIG. 1. The optimization engine 110 in the server computing device 106 receives (202) data from the input data sources 108 for use in generating an asset withdrawal optimization plan, including (i) customer portfolio data associated with a customer's investment portfolio account and (ii) research data associated with the assets in the customer's investment portfolio account. The customer portfolio data (e.g., received from the customer profile data source 108a and the customer account data source 108b) can include a list of the securities and share amounts, and related information, that are currently held in the customer's investment portfolio account. Other types of information incorporated into the customer portfolio data include, but are not limited to: a customer-specific benchmark that may have broad asset-class level target weights and narrow asset-class level target weights; portfolio attributes (e.g., active/passive), customer-specific portfolio tilts (e.g., technology sector focused), customer-specific restrictions, customer's state of residence, and the like. The customer portfolio data can also include the current price for the shares in the portfolio investment account, a broad asset-class classification, a narrow asset-class classification, an active/passive classification, distribution analysis data (e.g., analysis of how the shares in the portfolio account are apportioned across sectors, markets, indices, etc.), acquisition price of the shares, and acquisition dates of the shares.

The above-described customer portfolio data is received by the optimization engine 110 for use in determining a customized and beneficial withdrawal optimization plan for gifting and/or withdrawing assets from the customer's investment portfolio account. In some cases, part or all of the customer portfolio data is stored in the analysis database 112 for subsequent use by the optimization engine 110. In addition, in some cases the optimization engine 110 converts and/or formats the incoming data to comply with requirements of the engine 110 and to improve processing speed and accessibility of the data in order to generate the optimization plan more efficiently and quickly.

The optimization engine 110 also receives research data from a plurality of different data sources, such as the fundamental ratings data source 108c, the quantitative model ratings data source 108d, and the portfolio manager alpha scores data source 108e. The fundamental ratings data source 108c can provide information such as fundamental analyst security ratings (e.g., from a global asset allocation research database) that can be mapped to the securities and share amounts contained in the customer's investment portfolio account. The quantitative model ratings data source 108d can provide information to measure and compare attributes or metrics (e.g., earnings per share, discounted cash flow, option pricing) of the securities and share amounts in the customer's investment portfolio account. The portfolio manager alpha scores data source 108e can provide information relating to a measure of performance (e.g., return of a fund relative to a benchmark) of certain assets in the customer's investment portfolio account. Each of the research data elements can be used by the optimization engine 110 to determine a customized and beneficial withdrawal optimization plan for gifting and/or withdrawing assets from the customer's investment portfolio account.

Continuing with step 202 in FIG. 2, the optimization engine also receives (iii) customer preference data 109 from the customer. The customer preference data 109, as mentioned above, includes information relating to the amount (e.g., in dollar value and/or specific types of assets) that the customer wants to withdraw from the investment portfolio account. The customer preference data 109 also includes information indicative of the customer's preferences and/or goals in initiating the asset withdrawal. For example, the customer can provide an indication of the relative importance/priority to him or her of certain metrics (also called optimization criteria) employed by the optimization engine 110 in generating an asset withdrawal optimization plan, such as: broad asset-class level allocation, narrow asset-class level allocation, portfolio attributes (e.g., active/passive), fundamental security ratings, quantitative model security ratings, and portfolio manager security alpha scores. For example, a customer may prefer that the fundamental security ratings associated with securities and share amounts in the investment portfolio account are more important than portfolio manager security alpha scores when making an asset withdrawal decision. Thus, the customer may provide an indication (e.g., a weight) of the relative importance of these optimization criteria to the optimization engine 110.

In some embodiments, the customer preference data 109 is provided by the customer via a user interface at the client device 102. FIG. 3 is an exemplary user interface 300 for providing user-selected optimization criteria for use in determining a customized and beneficial asset withdrawal from an investment portfolio account, using the system 100 of FIG. 1. The user interface 300 includes a series of user inputs (e.g., sliders 302 and 304) that enable a customer to indicate the relative importance (or weight) to him or her of various factors that the optimization engine 110 analyzes when generating the asset withdrawal optimization plan. The sliders 302 relate to the relative importance of asset class deviations in the overall portfolio account. For example, the customer can select a relative importance (e.g., low to high) of a primary asset class and a secondary asset class by moving the slider along the bar.

The sliders 304 relate to the relative importance of industry ratings in analyzing the securities and share amounts in the portfolio account. For example, the customer can indicate that Fidelity ratings should be given a higher weight by the optimization engine 110 when determining which assets to withdraw from the portfolio account, while Morningstar ratings should be afforded low weight. The sliders 304 can also include several customer-specific optimization criteria (e.g., ‘User (Custom)1’, etc.) that enables a customer to customize the optimization plan results to his or her specific goals and preferences. The customer-specific optimization criteria can be defined in advance by a customer and implemented in the system 100 for use by the optimization engine 110.

The user interface 300 shows the customer the impact that the selected weight will have on the portfolio account after an asset withdrawal has been completed based upon the optimization plan generated by the optimization engine. For example, the total deviation (%) of the primary asset class in the customer's portfolio investment account changes from 4.32% to 2.12% after the asset withdrawal when the customer indicates a weight near the high end of the slider bar. The customer can also click the detail button at the right of each slider bar to see the detail of the proposed asset withdrawal.

The user interface 300 also includes a checkbox corresponding to each slider bar that enables a customer to indicate that certain optimization criteria are not important at all and should be afforded no weight by the optimization engine 110 in generating the optimization plan. For example, as shown in FIG. 3 the active/passive mix checkbox is selected and the corresponding slider bar is grayed out—thereby disabling it from interaction by the customer.

Also, in some embodiments, the user interface 300 can include a user input field 306 for the customer to provide a desired withdrawal amount (in dollars) of asset value out of the portfolio investment account. The optimization engine 110 receives the withdrawal amount to use as a threshold to match when generating the asset withdrawal optimization plan.

Turning back to FIG. 2, when the customer has provided the customer preference data 109 to the optimization engine 110 and the optimization engine has received the customer portfolio data and the research data, the optimization engine 110 analyzes (204) the customer portfolio data, the research data, and the customer preference data to generate an asset withdrawal optimization plan for the customer's investment portfolio account. Generally, the asset withdrawal optimization plan comprises a proposed withdrawal of specific securities and share amounts out of the portfolio account that results in the most favorable, or in some cases, least negative impact on the account based upon the optimization criteria provided by the customer and based upon the desired asset withdrawal amount indicated by the customer.

The analysis step 204 is comprised of three sub-parts. First, the optimization engine 110 determines (204a) a proposed withdrawal of securities and share amounts from the investment portfolio account. Next, the optimization engine 110 selects (204b) a set of securities and share amounts in the portfolio account that conforms to the proposed withdrawal determined in step 204a. Then, the optimization engine 110 generates the asset withdrawal optimization plan based upon the selected set of securities and share amounts. Each of these steps is described in greater detail below.

To determine a proposed withdrawal of securities and share amounts out of the investment portfolio account, the optimization engine 110 performs a series of analysis steps to maximize a benefit value to the customer as a result of the withdrawal of shares from the account. In other words, the engine 110 analyzes the data to determine which assets to withdraw from the portfolio in order to both (i) match the asset withdrawal amount desired by the customer and (ii) maximize the utility or benefit to the customer according to the optimization criteria used by the engine 110. In some cases, the benefit value corresponds to the most positive impact on the portfolio resulting from the withdrawal, while in other cases the benefit value corresponds to the least negative impact on the portfolio-according to the range of scenarios generated by the optimization engine 110 during its analysis.

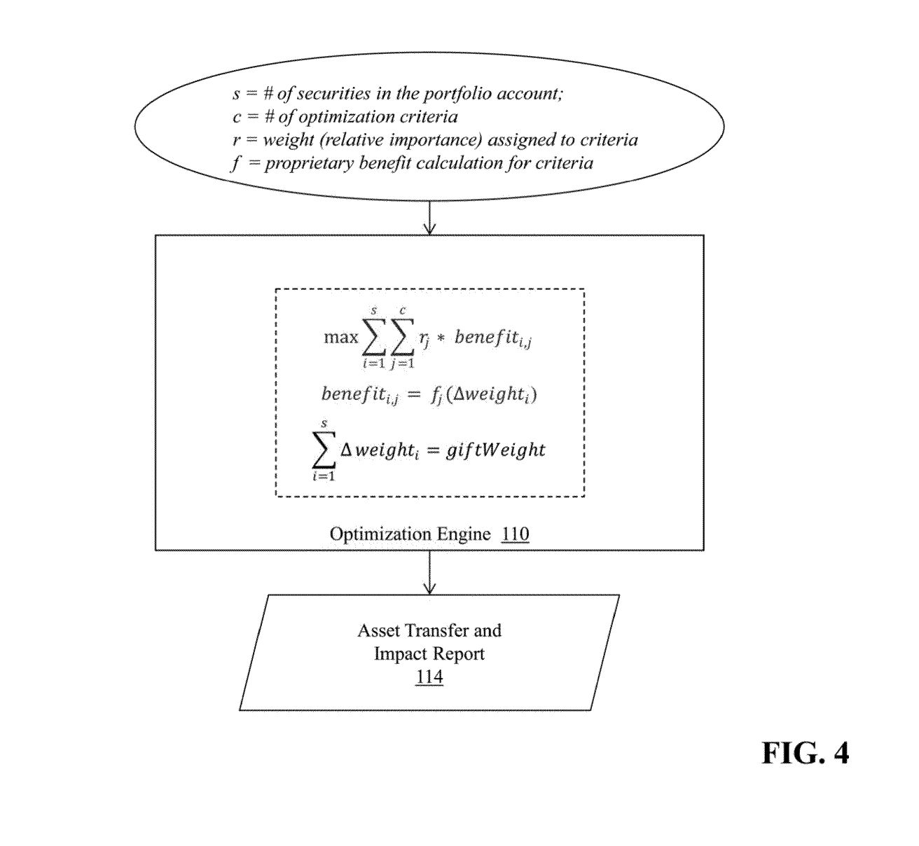

The optimization engine 110 maximizes the benefit value to the customer based upon at least the number of the securities in the portfolio account, the optimization criteria selected by the user, and the weights assigned to each of the optimization criteria by the customer. The optimization engine 110 attempts to maximize the utility or benefit across every security share in the portfolio account and across every optimization criteria. FIG. 4 is a detailed block diagram of the optimization engine 110 of FIG. 1 to show how the engine 110 analyzes the customer portfolio data, research data, and customer preference data to generate the asset withdrawal optimization plan.

As shown in FIG. 4, the optimization engine 110 determines three parameters that are derived from data received from the input data sources 108:
s=# of securities in the portfolio account;
c=# of optimization criteria used by the optimization engine;
r=weight (also called relative importance) assigned to the optimization criteria by the engine and/or the customer; and
f=the proprietary benefit calculation for each of the criteria.

The optimization engine 110 determines the maximum benefit value according to the following algorithms:

$$max {\sum }_{i = 1}^{s} {\sum }_{j = 1}^{c} {r}_{j} * {benefit}_{i , j}$$

$${benefit}_{i , j} = {f}_{j} ( Δ {weight}_{i} )$$

$${\sum }_{i = 1}^{s} Δ {weight}_{i} = giftWeight$$

In some embodiments, the optimization engine 110 requires a plurality of iterations of the benefit value, including the generation of many scenarios, in order to determine a proposed asset withdrawal that maximizes the benefit value to the customer.

The optimization engine 110 also matches the proposed asset withdrawal to the withdrawal amount desired by the customer. For example, the engine 110 determines a set of shares that equal the withdrawal amount, or gets as close to the withdrawal amount while still providing the maximum benefit value as described above. The engine 110 saves the determined set of shares as a proposed withdrawal.

Once the optimization engine 110 has determined the structure of the proposed withdrawal that maximizes the benefit value and matches the withdrawal amount desired by the customer, the engine 110 selects (204b) a set of securities and share amounts in the portfolio that conforms to the proposed withdrawal. The optimization engine 110 then generates (204c) the asset withdrawal optimization plan according to the selected set of securities and share amounts.

The asset withdrawal optimization plan sets forth the identity of the securities and share amounts to be withdrawn, as well as illustrates one or more effects (or impacts) on the portfolio account when the selected set of securities and share amounts is withdrawn from the portfolio account. For example, the asset withdrawal optimization plan can include a list of assets (identified by any number of characteristics, including security type, security ticker, security name) and the like, and the corresponding shares to be withdrawn. The asset withdrawal optimization plan can also include representations or illustrations of the impact that such a withdrawal will have on the portfolio account—such as impact on broad asset-class level, impact on narrow-asset class level, impact on portfolio attributes (e.g., passive/active), change to the fundamental research rating of the portfolio account, impact on the quantitative model rating of the portfolio account, impact on the portfolio manager alpha score, the total portfolio re-allocation cost and/or benefit, and the like. The optimization engine 110 can store the generated asset withdrawal optimization plan in the analysis database 112 for later retrieval, processing, and transmission.

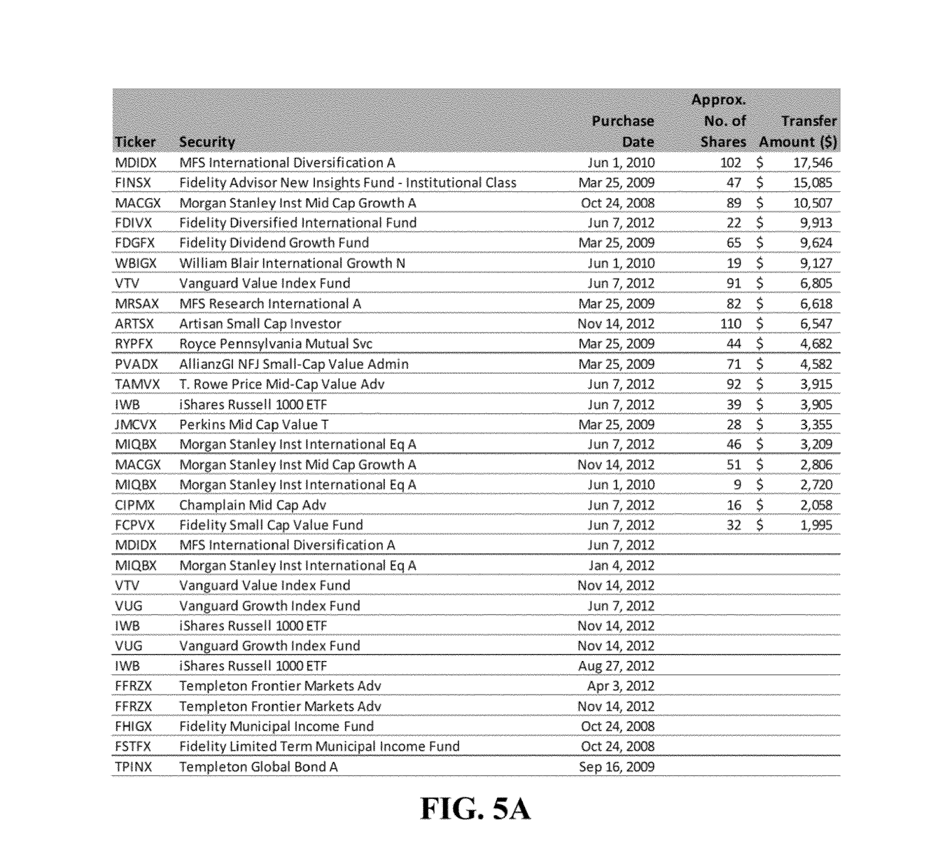

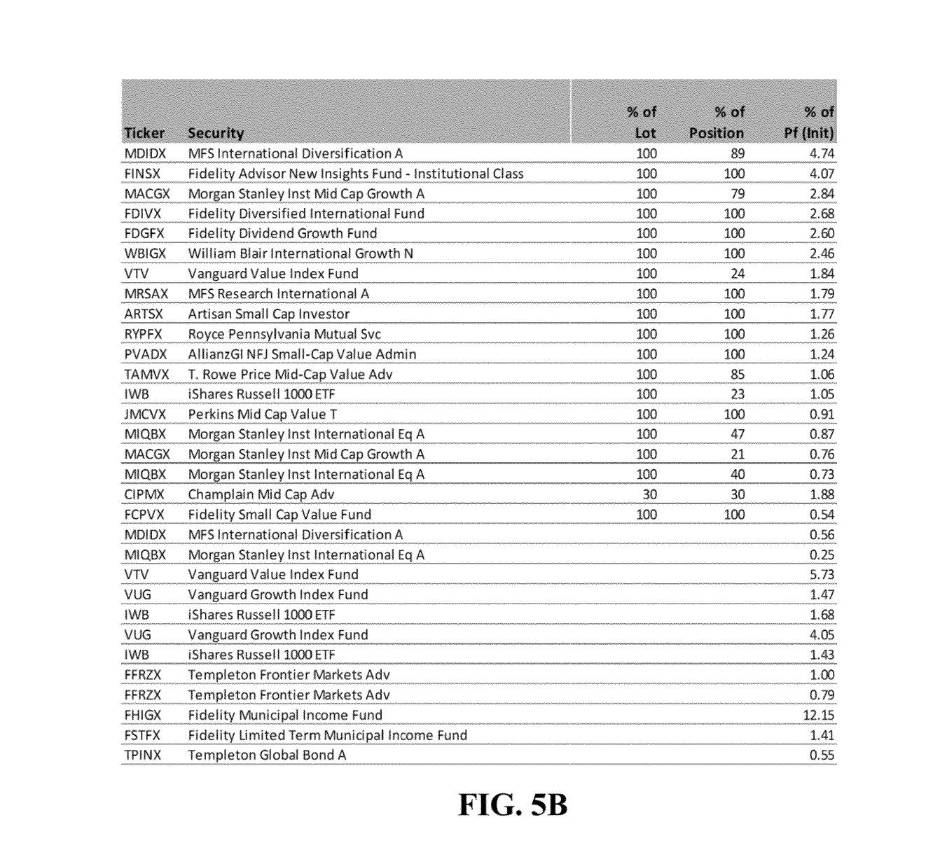

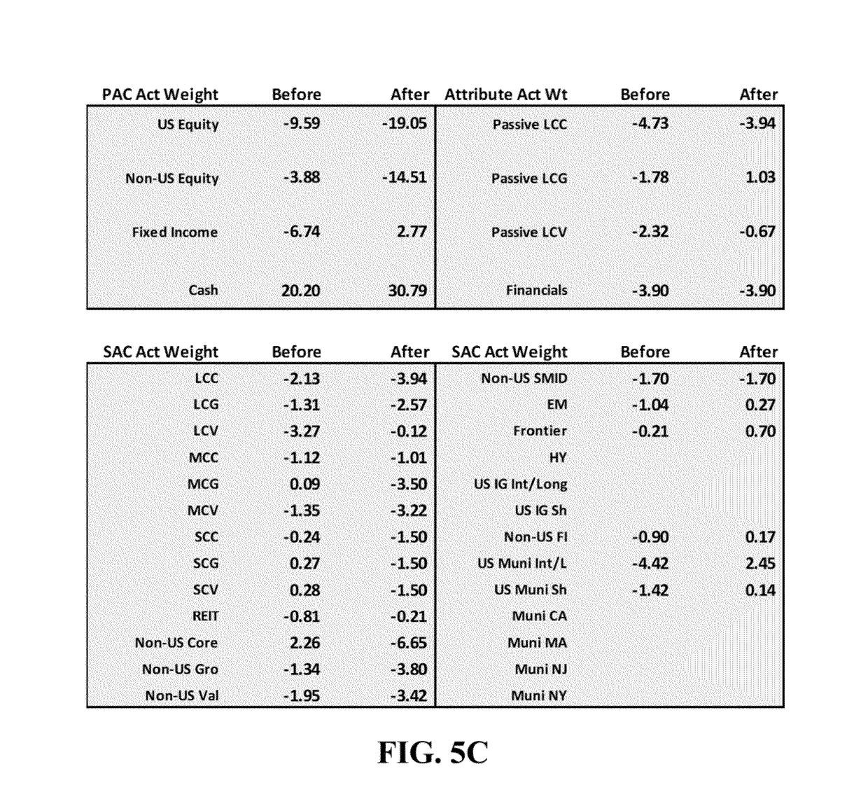

FIGS. 5A-5C are elements of an exemplary asset withdrawal optimization plan generated by the optimization engine 110. FIG. 5A depicts a list of securities and share amounts selected by the optimization engine 110 for withdrawal from the portfolio account. The list includes the ticker symbol and name for each security in the account, the purchase date for each security, the approximate number of shares, and the withdrawal amount (in dollars) for each asset to be withdrawn. For certain assets in the bottom portion of the list, no withdrawal will occur—indicated by a blank withdrawal amount.

FIGS. 5B and 5C depict impacts on the distribution of the portfolio account that results from withdrawal of the assets listed in FIG. 5A. FIG. 5B depicts the percentage of the security that is being withdrawn from the account, the percentage of the position that is being withdrawn, and the percentage of the overall portfolio that is being withdrawn. FIG. 5C depicts the impact on the primary asset class (PAC) weights and secondary asset class (SAC) weights in the portfolio account both before and after the asset withdrawal.

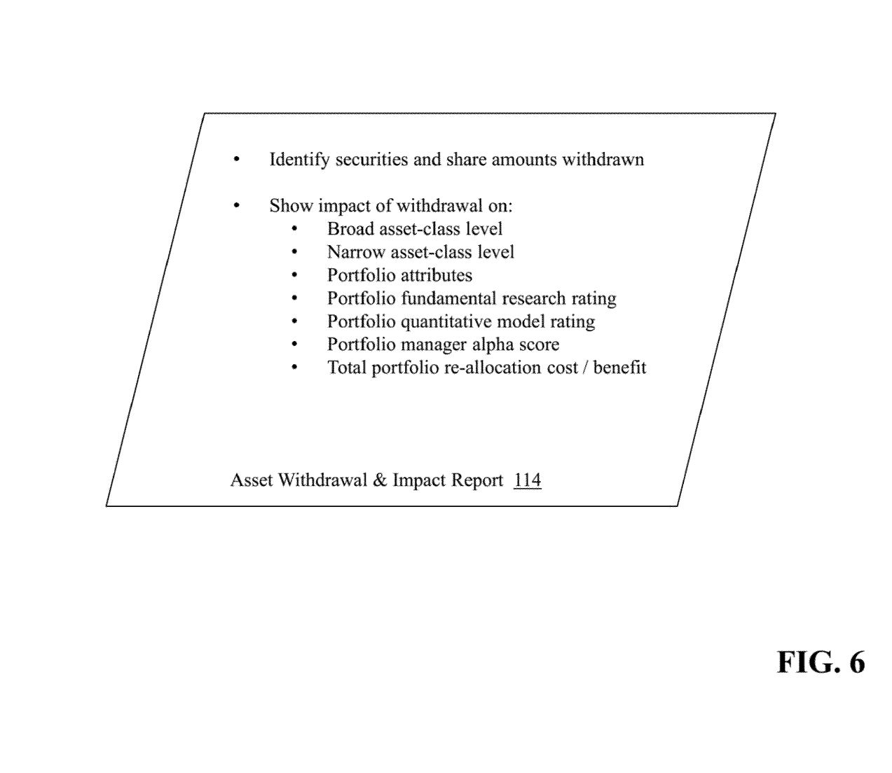

The optimization engine 110 transfers (206) the generated asset withdrawal optimization plan to a remote computing device (e.g., client device 102) as explained here. The optimization engine 110 can combine the elements of the asset withdrawal optimization plan depicted in FIGS. 5A through 5C into an asset withdrawal and impact report 114 to be transmitted to the customer (e.g., via client device 102). FIG. 6 is an exemplary asset withdrawal and impact report generated by the optimization engine 110. As described above, the asset withdrawal and impact report 114 includes information such as the identity of the securities and share amounts that are withdrawn (or proposed to be withdrawn), and the impact of said withdrawal on a variety of characteristics and ratings that define the portfolio account. The report 114 summarizes the proposed asset withdrawal for the customer and provides information that can aid in determining whether to execute the proposed withdrawal.

It should be appreciated that, in some embodiments, the asset withdrawal and impact report 114 is transmitted to a remote computing device associated with an investment advisor associated with the customer. Also, the report 114 can be transmitted to the customer/advisor in any number of ways, including for display on a computing device, email, digital file, postal mail, and the like.

In some embodiments, the optimization engine 110 can receive confirmation from the customer to execute the asset withdrawal in accordance with the generated optimization plan. The optimization engine 110 can receive the confirmation, e.g., via a command from the client device 102. The optimization engine 110 transmits the optimization plan or, in some cases, a plurality of security transaction instructions that conform to the optimization plan, to a trading engine coupled to the server computing device 106. The trading engine can automatically execute the security transactions that conform to the optimization plan, such that securities and share amounts are withdrawn from the investment portfolio account and the proceeds from such withdrawals are deposited in the portfolio account (e.g., as cash) or in another account designated by the customer.

The following are example use cases for asset withdrawal recommendations generated by the optimization engine 110 using the process herein and to be included in the asset withdrawal optimization plan.

Case #1—Mitigating the Impact on Asset Allocation

In this example, the customer's investment portfolio account has an underweight to its equity exposure in relation to a given benchmark. The customer has indicated that a risk associated with the portfolio account be kept within a specific threshold. Therefore, if further equity positions are withdrawn from the account, it would increase the underweight further and also increase overall risk of the portfolio account. The optimization engine 110 determines an asset withdrawal optimization plan that includes the withdrawal of a fixed income position instead of an equity position.

Case #2—Eliminating Poorly Rated Positions

In this example, the investment portfolio account includes a poorly-rated equity position which has introduced a high level of risk to the portfolio. Again, the customer has indicated that a risk associated with the portfolio account be kept within a specific threshold. The optimization engine 110 determines an asset withdrawal optimization plan that includes the withdrawal of the poorly-rated position.

Case #3—Improving a Portfolio Account's Large Cap Passive/Active Split

In this example, the investment portfolio account has an active fund overweight. The customer has indicated a preference for a particular active/passive exposure level. Therefore, reducing the active fund overweight would bring the portfolio's active exposure to a level that conforms to the customer's preference. The optimization engine 110 determines an optimization plan that withdraws an active fund, rather than a passive fund.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback, and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer®, available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for determining a customized and beneficial asset withdrawal from an investment portfolio account, the method comprising:
receiving, by a server computing device from a plurality of data sources, (i) customer portfolio data associated with a customer's investment portfolio account, the account containing a plurality of securities and share amounts, (ii) research data associated with the plurality of securities and share amounts, and (iii) customer preference data;
analyzing, by an optimization engine executing in the server computing device, the customer portfolio data, research data, and customer preference data to generate an asset withdrawal optimization plan for the investment portfolio account, the analyzing comprising:
determining a proposed withdrawal of securities and share amounts out of the investment portfolio account, wherein the proposed withdrawal
(i) maximizes a benefit value to the customer based upon at least a number of securities in the investment portfolio account, optimization criteria selected by the customer, and a weight assigned to each of the optimization criteria by the customer, and
(ii) matches a predetermined asset withdrawal amount,
selecting a set of securities and share amounts in the portfolio account that conforms to the proposed withdrawal, and
generating the asset withdrawal optimization plan based upon the selected set of securities and share amounts, wherein the asset withdrawal optimization plan illustrates one or more effects on the portfolio account when the selected set of securities and share amounts is withdrawn from the portfolio account; and
transmitting, by the optimization engine, the asset withdrawal optimization plan to a remote computing device.

2. The method of claim 1, further comprising automatically executing, by a trading engine coupled to the server computing device, a plurality of security transactions based upon the asset withdrawal optimization plan to withdraw the selected set of securities and share amounts from the investment portfolio account.

3. The method of claim 1, wherein maximization of the benefit value is determined by
$$max {\sum }_{i = 1}^{s} {\sum }_{j = 1}^{c} {r}_{j} * {benefit}_{i , j}$$
$${benefit}_{i , j} = {f}_{j} ( Δ {weight}_{i} )$$
$${\sum }_{i = 1}^{s} Δ {weight}_{i} = giftWeight$$
wherein
s=the number of securities in the portfolio account,
c=the number of optimization criteria,
r=the weight assigned to each criteria, and
f=the proprietary benefit calculation for each of the criteria.

4. The method of claim 1, wherein the set of customer portfolio data includes customer-specific benchmark data corresponding to a level of investment risk desired by the customer.

5. The method of claim 4, wherein the customer-specific benchmark data includes a set of broad asset-class level target weights and a set of narrow asset-class level target weights.

6. The method of claim 1, wherein the set of customer portfolio data includes security data associated with the plurality of securities and share amounts in the account.

7. The method of claim 6, wherein the security data includes current price, broad asset class classification, narrow asset class classification, active/passive classification, distribution analysis data, acquisition price, and acquisition date.

8. The method of claim 1, wherein the research data associated with the plurality of securities and share amounts includes fundamental analyst security ratings, quantitative model security ratings, and portfolio manager alpha scores.

9. The method of claim 1, wherein the customer preference data includes the predetermined asset withdrawal amount.

10. The method of claim 1, wherein the customer preference data includes identification of at least some of the optimization criteria and the weight assigned to each of the optimization criteria.

11. The method of claim 10, wherein the weight signifies a relative importance of each of the optimization criteria to the customer.

12. The method of claim 1, wherein the customer preference data is provided by the customer via a remote computing device coupled to the server computing device.

13. A computerized system for determining a customized and beneficial asset withdrawal from an investment portfolio account, the system comprising:
a server computing device configured to
receive, from a plurality of data sources, (i) customer portfolio data associated with a customer's investment portfolio account, the account containing a plurality of securities and share amounts, (ii) research data associated with the plurality of securities and share amounts, and (iii) customer preference data;
an optimization engine executing on the server computing device, the optimization engine configured to:
analyze the customer portfolio data, research data, and customer preference data to generate an asset withdrawal optimization plan for the investment portfolio account, the analyzing comprising:
determining a proposed withdrawal of securities and share amounts from the investment portfolio account, wherein the proposed withdrawal
(i) maximizes a benefit value to the customer based upon at least a number of securities in the investment portfolio account, optimization criteria selected by the customer, and a weight assigned to each of the optimization criteria by the customer, and
(ii) matches a predetermined asset withdrawal amount,
selecting a set of securities and share amounts in the portfolio account that conforms to the proposed withdrawal, and
generating the asset withdrawal optimization plan based upon the selected set of securities and share amounts, wherein the asset withdrawal optimization plan illustrates one or more effects on the portfolio account when the selected set of securities and share amounts is withdrawn from the portfolio account; and
transmit the asset withdrawal optimization plan to a first remote computing device.

14. The system of claim 13, the server computing device further executing a trading engine, the trading engine configured to automatically execute a plurality of security transactions based upon the asset withdrawal optimization plan to withdraw the selected set of securities and share amounts from the investment portfolio account.

15. The system of claim 13, wherein maximization of the benefit value is determined by
$$max {\sum }_{i = 1}^{s} {\sum }_{j = 1}^{c} {r}_{j} * {benefit}_{i , j}$$
$${benefit}_{i , j} = {f}_{j} ( Δ {weight}_{i} )$$
$${\sum }_{i = 1}^{s} Δ {weight}_{i} = giftweight$$
wherein
s=the number of securities in the portfolio account,
c=the number of optimization criteria,
r=the weight assigned to each criteria, and
f=the proprietary benefit calculation for each of the criteria.

16. The system of claim 13, wherein the set of customer portfolio data includes customer-specific benchmark data corresponding to a level of investment risk desired by the customer.

17. The system of claim 16, wherein the customer-specific benchmark data includes a set of broad asset-class level target weights and a set of narrow asset-class level target weights.

18. The system of claim 13, wherein the set of customer portfolio data includes security data associated with the plurality of securities and share amounts in the account.

19. The system of claim 18, wherein the security data includes current price, broad asset class classification, narrow asset class classification, active/passive classification, distribution analysis data, acquisition price, and acquisition date.

20. The system of claim 13, wherein the research data associated with the plurality of securities and share amounts includes fundamental analyst security ratings, quantitative model security ratings, and portfolio manager alpha scores.

21. The system of claim 13, wherein the customer preference data includes the predetermined asset withdrawal amount.

22. The system of claim 13, wherein the customer preference data includes identification of at least some of the optimization criteria and the weight assigned to each of the optimization criteria.

23. The system of claim 22, wherein the weight signifies a relative importance of each of the optimization criteria to the customer.

24. The system of claim 13, wherein the customer preference data is provided by the customer via a second remote computing device coupled to the server computing device.

25. A computer program product, tangibly embodied in a non-transitory computer readable storage medium, for determining a customized and beneficial asset withdrawal from an investment portfolio account, the computer program product including instructions operable to cause a server computing device, upon which an optimization engine is executing, to:
receive, from a plurality of data sources, (i) customer portfolio data associated with a customer's investment portfolio account, the account containing a plurality of securities and share amounts, (ii) research data associated with the plurality of securities and share amounts, and (iii) customer preference data;
analyze the customer portfolio data, research data, and customer preference data to generate an asset withdrawal optimization plan for the investment portfolio account, the analyzing comprising:
determining a proposed withdrawal of securities and share amounts out of the investment portfolio account, wherein the proposed withdrawal
(i) maximizes a benefit value to the customer based upon at least a number of securities in the investment portfolio account, optimization criteria selected by the customer, and a weight assigned to each of the optimization criteria by the customer, and
(ii) matches a predetermined asset withdrawal amount,
selecting a set of securities and associated shares in the portfolio account that conforms to the proposed withdrawal, and
generating the asset withdrawal optimization plan based upon the selected set of securities and share amounts, wherein the asset withdrawal optimization plan illustrates one or more effects on the portfolio account when the selected set of securities and share amounts is withdrawn from the portfolio account; and
transmit the asset withdrawal optimization plan to a remote computing device.
